(19) United States
(12) Patent Application Publication
(10) Pub. No.: US 2011/0250331 A1
(43) Pub. Date: Oct. 13, 2011

(54) Thermal food cover and method

(76) Inventors: James D. Murray, Chicago, IL (US); Paul A. Crockett, Naperville, IL (US)

(21) Appl. No.: 12/798,866

(22) Filed: Apr. 13, 2010

(51) Int. Cl. A47J 39/02; B32B 3/06

(52) U.S. Cl. 426/418; 428/74

(57) ABSTRACT

A thermal food cover comprises a first layer comprising a fabric material and a second layer coupled with the first layer and comprising an insulative material. The thermal food cover further comprises a third layer coupled with the first layer, and comprising a food-grade, thermally resistant, material. In another aspect, a method for retaining thermal properties of a food item, comprises placing the food item on a surface. The method further comprises covering the food item with a thermal food cover to retain thermal properties of the food item, the food cover comprising a first layer comprising a fabric material, a second layer coupled with the first layer and comprising an insulative material, and a third layer coupled with the first layer, and comprising a food-grade, thermally resistant, material.

### TECHNICAL FIELD

This disclosure is directed to maintaining a food product's thermal properties, and more specifically, a thermal food cover and method for maintaining a food's thermal properties.

### BACKGROUND ART

Often with food items, it is desirable to maintain the temperature of the food item after the food has been prepared, and while the food item is being served. For example, a particular item of food may be baked or broiled in an oven, and removed from the oven to be served. While gathering other items for the dinner, that food item begins to cool.

Other food items may sit at ambient temperature for some time (i.e., several minutes, to an hour or more) before/while they are being consumed. For example, dishes at a meal where additional servings are desired, a pizza, or a cup of hot beverage such as coffee or tea, may all sit for several minutes or longer at ambient temperature before they are consumed. While these foods are sitting at the ambient temperature before being consumed, the temperature of the food item will typically fall quickly.

To help partially alleviate this problem, food has been kept completely enclosed within the container in which it is housed. For example, where food is served in a casserole dish, a cover of the casserole dish may be left on the food to help reduce heat loss. When pizza is being served, the pizza may be left in the pizza box with the lid closed to reduce heat loss. However, such covers and/or containers may be bulky to deal with while serving the foods, and may only marginally help to maintain the thermal properties of the food contained therein.

This invention is directed to overcoming one or more of the problems discussed above.

### SUMMARY OF THE INVENTION

In one aspect, a thermal food cover comprises a first layer comprising a fabric material and a second layer coupled with the first layer and comprising an insulative material. The thermal food cover further comprises a third layer coupled with the first layer, and comprising a food-grade, thermally resistant, material.

In one embodiment, the third layer of the thermal food cover may be further coupled with the second layer. In another embodiment, the third layer is coupled with the first layer about a perimeter of the thermal food cover. In another embodiment, the fabric material is comprised of a polyester-cotton blend fabric.

In yet another embodiment, the coupling of the second layer with the first layer, and the coupling of the third layer with the second layer, utilizes a threaded sewing stitch. In a further embodiment, the sewing stitch is a modified chain stitch. In an alternate further embodiment, the sewing stitch is a lock stitch.

In another embodiment, the insulative material comprises a batting material. In another embodiment, the food-grade material comprises a food-grade, thermally resistant, polyester polyurethane film. In a yet further embodiment, the food grade, thermally resistant, polyester polyurethane film is capable of withstanding temperatures of at least 160 degrees Celsius.

In yet another embodiment, a biasing fabric material is coupled about a perimeter of the thermal food cover. In a further embodiment, the biasing fabric material comprises a polyester-cotton blend fabric.

In another embodiment, the food cover has a substantially planar portion, and further comprises a collar extending at an angle from the plane of the substantially planar portion. In another embodiment, the second layer is coupled with the first layer to cause a quilting effect.

In another aspect, a thermal food cover comprises a first layer comprising a polyester-cotton fabric blend, and a second layer coupled with the first layer via a threaded sewing stitch and comprising a polyester fiber batting material. The thermal food cover further comprises a third layer coupled with the first layer about the perimeter of the food cover, and comprising a food-grade, thermally resistant, polyester polyurethane film material.

In another aspect, a method for retaining thermal properties of a food item comprises placing the food item on a surface. The method further comprises covering the food item with a thermal food cover to retain thermal properties of the food item, the food cover comprising a first layer comprising a fabric material, a second layer coupled with the first layer and comprising an insulative material, and a third layer coupled with the first layer, and comprising a food-grade, thermally resistant, material.

In one embodiment, the covering the food item includes covering a container housing the food, where the food item is housed in a container.

In another embodiment, the covering the food item with the thermal food cover retains thermal properties of the food item includes covering the food item with the thermal food cover to retard the escape of heat from the food item. In yet another embodiment, the covering the food item with the thermal food cover to retain thermal properties of the food item includes covering the food item with the thermal food cover to retard the absorption of heat by the food item.

### BRIEF DESCRIPTION OF THE SEVERAL VIEWS OF THE DRAWINGS

FIG. 1 is a top view of a thermal food cover in accordance with an embodiment of the invention;

FIG. 2 is a bottom view of the thermal food cover of FIG. 1, in accordance with an embodiment of the invention;

FIG. 3 is a partial-sectional view of the food cover of FIG. 1, along the line A-A, in accordance with an embodiment of the invention;

FIG. 4 is a close-up of a partial sectional-view of the food cover of FIG. 1 along the line A-A and showing some perspective features, in accordance with an embodiment of the invention;

FIG. 5 is a top view of a thermal food cover in accordance with another embodiment of the invention;

FIG. 6 is a bottom view of the thermal food cover of FIG. 5, in accordance with an embodiment of the invention;

FIG. 7 is a perspective view of a thermal food cover, in accordance with another embodiment of the invention;

FIG. 8 is a close-up of a partial side view of the food cover of FIG. 7, in accordance with an embodiment of the invention; and

FIG. 9 is a close-up of a partial sectional-view of the food cover of FIG. 7 along the line B-B and showing some perspective features, in accordance with an embodiment of the invention.

### DETAILED DESCRIPTION OF THE PREFERRED EMBODIMENT

In one aspect, a thermal food cover is provided comprising a first layer comprising a fabric material and a second layer coupled with the first layer and comprising an insulative material. The thermal food cover further comprises a third layer coupled with the first layer and comprising a food-grade, thermally resistant, material.

In another aspect, a method for retaining thermal properties of a food item comprises placing the food item on a surface. The method further comprises covering the food item with a thermal food cover to retain thermal properties of the food item. The food cover comprises a first layer comprising a fabric material, a second layer coupled with the first layer and comprising an insulative material, and a third layer coupled with the first layer, and comprising a food-grade, thermally resistant, material.

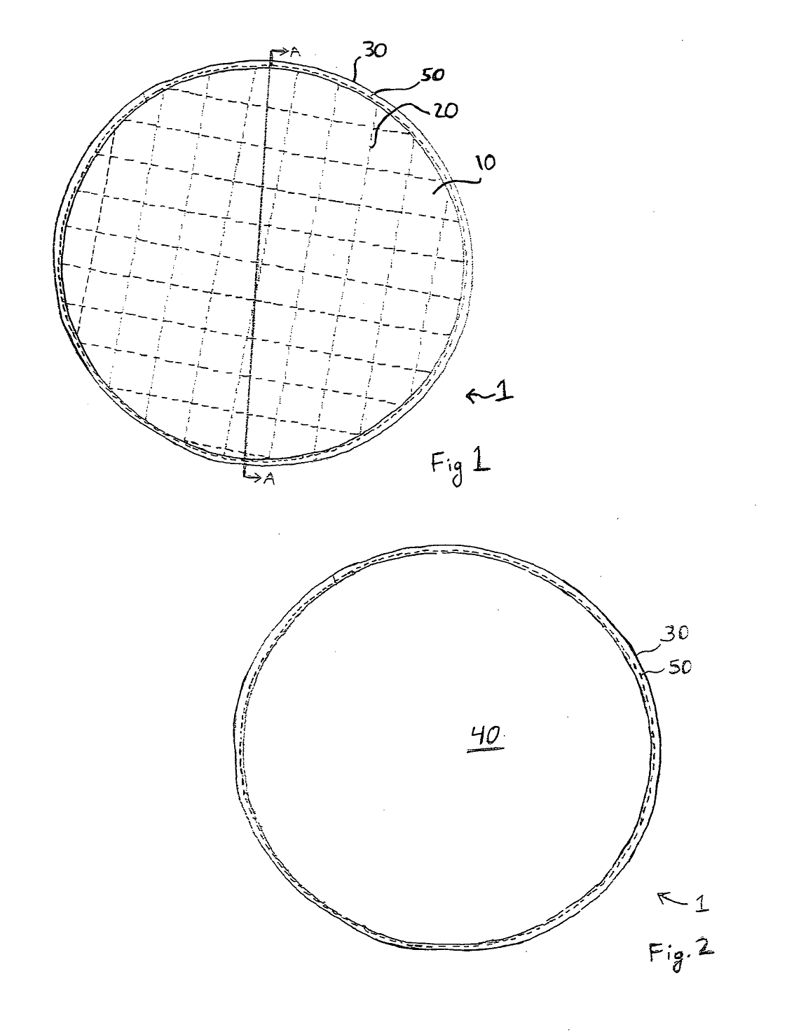

An embodiment of the thermal food cover will be discussed with respect to FIGS. 1-4.

FIG. 1 is a top view of a thermal food cover 1 in accordance with an embodiment of the invention.

As shown in FIG. 1, the thermal food cover 1 includes a first layer comprising a fabric material 10. The first layer may be coupled with a second insulative layer (not shown) and a third food-grade, thermally resistant, material (not shown). The first layer 10 and second layer 60 may be coupled with threaded sewing stitches 20. In a further embodiment, the thermal food cover 1 may include a biasing fabric material 30, coupled about the perimeter of the food cover 1. The biasing fabric material 30 may be coupled about the perimeter of the food cover, for example, using threaded sewing stitches 50.

FIG. 2 is a bottom view of the thermal food cover 1 of FIG. 1, in accordance with an embodiment of the invention. A third layer comprising food-grade, thermally resistant material 40 is shown. In a further embodiment, the biasing fabric material 30 is shown coupled about the perimeter of the food cover 1 utilizing the threaded sewing stitches 50.

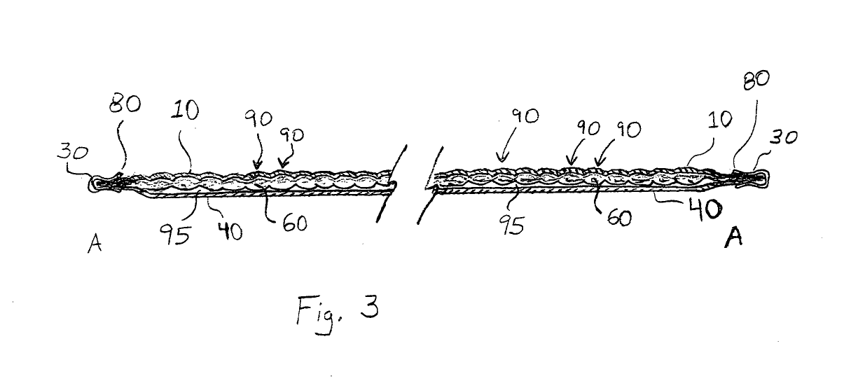

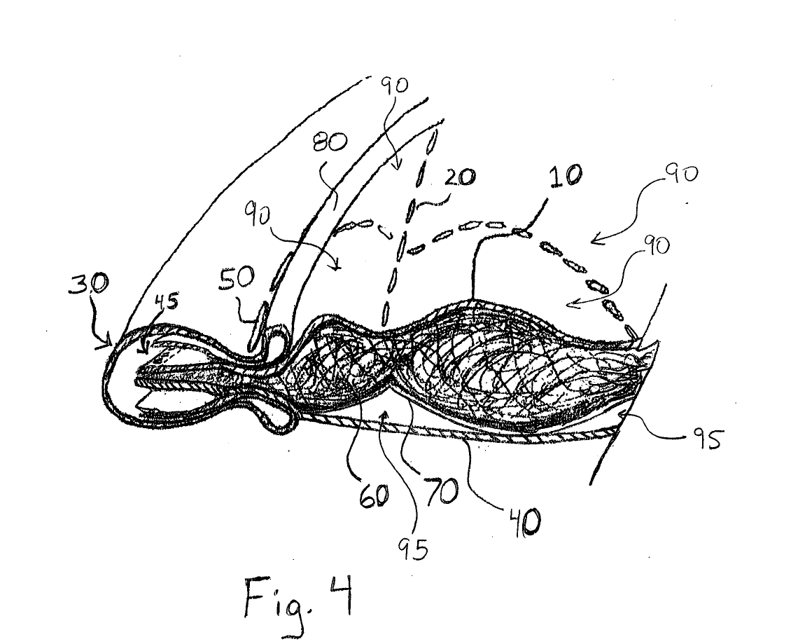

FIG. 3 is a partial-sectional view of the food cover 1 of FIG. 1, along the line A-A, in accordance with an embodiment of the invention. FIG. 4 is a close-up of a partial sectional-view, of the food cover 1 of FIG. 1, along the line A-A and showing some perspective features, in accordance with an embodiment of the invention. FIGS. 3 and 4 are not necessarily to scale, to particularly point out various features of the thermal food cover 1.

Referring to FIGS. 3 and 4, the first layer comprising the fabric material 10 is provided, and may be coupled with the second insulative layer 60 via threaded sewing stitches 20. Such threaded stitches 20 may couple the first layer 10 and second layer 60 together at many locations of the food cover 1, including locations other than along the perimeter of the food cover. It will be appreciated that such coupling of the first layer 10 and second layer 60 may occur along only the perimeter of the food cover 1 via the threaded sewing stitches shown at 45. The third food-grade, thermally resistant material 40 may be coupled with the first layer about a perimeter of the food cover 1, for example, via threaded sewing stitches 45. In the further embodiment, the threaded sewing stitches 50 may couple the biasing fabric material 30 about the perimeter of the food cover. Further shown in FIGS. 3 and 4 are a backing layer 70 of the insulative layer 60.

As shown in FIG. 4, the biasing fabric 30 may be folded under itself to form a bead, generally shown at 80. Such under-folding need not be provided however, in which case the beading would not be present.

The threaded sewing stitches 20 coupling the first layer 10 with the second insulative layer 60 may provide a quilting effect, where the sewing stitches 20 define a quilting pattern (shown in FIGS. 1, 3 and 4) that helps trap air within the individual quilts, some of which are generally shown at 90, thereby enhancing the insulative effects of the thermal food cover 1. The pattern of such quilting may differ from that shown in FIGS. 1, 3 and 4.

Where the first layer 10 is coupled with the second layer 60 at more than the perimeter of the food cover 1, and the third layer 40 is coupled with the first layer 10 about the perimeter of the food cover 1, there may be one or more voids created between the second layer 60 and the third layer 40, shown generally at 95. Such voids may further enhance the thermal retention qualities of the food cover 1, as will be appreciated by one skilled in the art.

In one embodiment, the first layer 10 comprising a fabric material may be comprised of a polyester/cotton fabric blend, such as a 65% polyester/35% cotton blend, for example, as sold by Richlin Fabrics Inc., of Kansas City Mo. Such fabric may be, for example, a broadcloth fabric having a 110×76 thread count, and may be preshrunk and color fast. Fabric blends with other thread counts may be utilized. Such fabric may be provided in a variety of colors and design patterns. Such colors and patterns are not functionally crucial to a particular embodiment of the food cover 1. Further, the blend of the polyester and cotton may be different, for example, a 50% polyester and 50% cotton blend. It will be appreciated that other fabric blends may be utilized in various blend proportions, and that the fabric blend may comprise of a single fabric, for example, 100% polyester fabric. Such fabric blend selected may be color-fast, capable of resisting shrinkage, and may further be wrinkle-resistant.

The second insulative layer 60 may be a batting material, for example, a 0.75 oz polyester fiber at 6.75 oz. per square yard. Other batting material may be utilized. Such batting material 60 may further include a 0.5 oz. non-woven scrim quilt-backer material to comprise the backing layer 70. It will be appreciated by one skilled in the art that the backing layer 70 may come separately from the batting material 60, and may be coupled with (i.e., sewn to) the batting material 60. In one embodiment, the batting material 60 is capable of entrapping air, thereby providing or further enhancing the insulative properties of the batting material.

The threaded sewing stitches 20 may be formed from lock sewing stitches, chain sewing stitches, or other stitches may be utilized. The threaded sewing stitches 20 need not follow any particular pattern of the first layer 10. The threaded sewing stitches 45 may be formed from a three-threaded serge (shown), or other stitches may be utilized. The threaded sewing stitch 50 may be formed from lock sewing stitches, chain sewing stitches, or other stitches may be utilized. The threaded sewing stitches 20 and/or 50 may be provided in any pattern, for example, straight line, zig zag, etc. . . . , or any other pattern.

The thread utilized for the threaded sewing stitches 20, 45 and/or 50 may be, for example, a nylon or spun polyester thread. Other threads may be utilized. Such thread may be resistant to stretch and/or snap-back. It will be appreciated that such thread may be provided in a variety of colors. The thread and/or the particular sewing stitch utilized for the threaded sewing stitches 20, 45 and/or 50 may be selected to allow the thermal food cover to remain durable after several washing and/or drying cycles that the food cover may be subjected to. The threaded sewing stitches 20 may be applied in any pattern, for example, diamond (shown in FIGS. 1 and 4), rectangular (not shown), or any other pattern, artistic or otherwise. As discussed above, the threaded stitches 20, though shown across much of the food cover 1, may be provided only about a perimeter of the food cover 1 in some embodiments, or may be completely left out in other embodiments. Such threaded stitches may, but need not, follow a design printed on the fabric being utilized for the first layer 10.

The third layer 40 comprising a food-grade, thermally resistant material, may be, for example, a polyester polyurethane film. Such film may be compliant with current United States Food and Drug Administration (FDA) Standards, for example, a Food Additive Regulation as defined at 21 C.F.R. 177.2600, revised as of Apr. 1, 2009, the contents of which are hereby incorporated by reference herein. Such film may further be processed to meet FDA Standards to be generally recognized as safe, under F.D.A. 21 C.F.R. 182.90, revised as of Apr. 1, 2009, the contents of which are hereby incorporated by reference herein, with ingredients sanctioned for food contact applications under 21 C.F.R. 175.300, revised as of Apr. 1, 2009, the contents of which are hereby incorporated by reference herein.

In one embodiment, such third layer comprising a food-grade, thermally resistant material 40 may be a Polyester Polyurethane Film as supplied by American Polyfilm, Inc. of Branfort Conn., for example, as part number VLM 3301, with an approximate thickness of 8 mils. Other thicknesses may be utilized. For example, thicknesses such as 6 mil, 7 mil, 9 mil or 10 mil may instead be utilized, without substantively affecting at least some functionality described herein. Such film comprising the third layer 40 may have the following characteristics:

| | | ASTM |
|---|---|---|
| | Test Value | Test Method |
| Durometer | 90 Shore A | D 2240 |
| Specific Gravity | 1.19 | D 792 |
| Elongation @ Break Elasticity | 515% | D 412 |
| Tensile Strength @ Break Elasticity | 5,400 psi | D 412 |
| 100% Modulus | 1500 psi | D 412 |
| 300% Modulus | 2950 psi | D 412 |
| Melt Range | 375-425° F. | |
| | (190-220° C.) | |

The ASTM Test Methods for D2240, D792 and D412 are well known in the art, and are hereby incorporated by reference herein, in their entirety.

Such film may be capable of good adhesive bonding to cloth, good weldability, good thermoformability and fair hydrolytic stability (polyester). Thermal resistance may include having a melting point of at least 375-425° F. (190-220° C.), however, it will be appreciated that other melting ranges may be utilized. For example, the melting point may be at least 160° C. The melting point may instead be any current minimum melting range/point set forth in any then-existing United States regulations for food-grade materials, as will be appreciated by one skilled in the art.

The biasing fabric material 30 may comprise a polyester/cotton blend fabric, for example a 50% polyester/50% cotton fabric blend. Such fabric may be, for example, a Demiway style, broadcloth 50% polyester/50% cotton blend with a 96×56 thread count, at 3.38 oz. per square yard, 2.61 yards/pound, with a 35/1 yarn size, for example, as provided by National Bias Binding Corp. of Brooklyn, N.Y. Other biasing fabrics may be utilized. Such biasing fabric may be provided in a variety of colors and patterns, selection of which will not substantively affect functionality of the food cover 1. The biasing fabric may be, for example, a 1½ inch centerfold or a 1¾ inch centerfold, of a length appropriate to line the perimeter of the food cover, where the particular sized centerfold utilized forms the bias shown at 30. As discussed above, the bias fabric may be folded under itself, forming the bead 80, as shown in FIG. 4. For example, in one embodiment where 1½ inch centerfold bias fabric is utilized, approximately ⅜ inch may be underfolded to form the bead 80 of FIG. 4. In another embodiment where 1¾ inch centerfold bias fabric is utilized, approximately 7/16 inch may be underfolded to form the bead 80 of FIG. 4.

In use, a food item may be placed onto a surface. Such food item may be in a container, such as a casserole dish or pizza housed within its container (i.e., box), or such item may be removed from its container, such as a pizza placed onto a surface such as a cutting or serving board. The food item may then be covered with the food cover 1, where the food cover comprises a first layer comprising a fabric material 10, a second layer 60 coupled with the first layer and comprising an insulative material, and a third layer 40 coupled with the first layer, and comprising a food-grade, thermally resistant, material. Covering the food item with the thermal food cover helps maintain the food item's thermal properties. For example, where the food is a hot food, the food cover retards the escape of heat from the item. Where the food item is housed in a container such as a casserole dish, the thermal food cover may be placed over the casserole dish (and thus the food item), thereby slowing and/or preventing the escape of heat from the item. The lid for the food container may be resting on the container when the thermal food cover is applied, or it will be appreciated that where the container lid (i.e., casserole dish lid) is not present, the thermal food cover may rest directly on the container, above or in contact with the food item within the container. Where the food item is not in a container, such as a pizza placed onto a surface such as a cutting or serving board, the food cover may be placed directly on and in contact with the food item, thereby retarding the escape of heat from the item.

It will be appreciated that such retention of thermal properties may include preventing the absorption of heat as well. For example, where the food item is cold, such as ice cream in a dish, the food cover 1 may be placed over the dish (and ice cream) either contacting the food item or resting above the food item, to prevent the absorption of heat by the food item.

The retention of thermal properties (i.e., retardation of heat escape or heat absorption) may be accomplished by the entrapment of gas (i.e., air) in the insulative layer 60 (for example a batting material). As will be appreciated by one skilled in the art, the retention of air within the insulative material of second layer 60 retards the escape of heat from the food item covered with the food cover 1. Similarly, where it is desired to prevent heat absorption by the food item, the retention of air within the insulative material of the second layer 60 resists the penetration of heat through the food cover to the food item. Further, the food cover 1 prevents insects dust or other debris from landing on the food item.

Where the first and second layers 10 and 60 are coupled at locations in addition to the perimeter of the food cover (i.e., as shown in FIGS. 1-4), via threaded stitches 20, the additional quilting effect from the quilting pattern formed by the threaded stitches 20 may provide additional insulative properties to heat loss and/or heat gain of the thermal food cover 1.

The food cover 1 has been described above to be circular in configuration. Such approximate circular dimensions may be, for example 12 inch, 15 inch or 18 inch diameters for covering food items such as pizzas or meats, or may be 4½ inch diameters for covering hot beverages, as will be appreciated by one skilled in the art. As discussed further below, it will be appreciated that the food cover may take other shaped-configurations as well.

The coupling of the first layer 10 and second layer 60, and first layer 10 and third layer 40 has been discussed as being accomplished using threaded sewing stitches 45 as a three threaded serge. However, it will be appreciated by one skilled in the art that other coupling of the respective layers may be utilized, such as other sewing stitches, a fabric adhesive, snaps, buttons, zippers, etc. . . . . It will be further appreciated that any combination of coupling means may be utilized. For example, the first layer 10 may be coupled with the second layer 60 using threaded sewing stitches, whereas the first layer 10 may be coupled with the third layer 40 using a suitable fabric adhesive.

It has been discussed above that the first, second and third layers 10, 60 and 40 respectively, have been coupled together by threaded sewing stitches 45. It will be appreciated by one skilled in the art that where the threaded sewing stitches 45 are not present, such coupling any of the first, second or third layers 10, 60 and 40 respectively, may be accomplished by the sewing stitches 50. Where the stitches 50 are not provided, the layers 10, 60 and 40 may be coupled via the threaded sewing stitches 20. In the latter case, the bias may not be present, providing an ‘unfinished’ edge, or the bias may be present and coupled to the thermal food cover via other fastening, for example, fabric adhesive.

It has been discussed above that the second insulative layer 60 extends to the outer edge of the thermal food cover 1. However, it will be appreciated by one skilled in the art that the second insulative layer 60 need not extend to the outside edge of the thermal food cover 1. For example, the second insulative layer may extend to an inner edge of the biasing strip 30 and held in place by threaded stitches 50. In the alternative, the second insulative layer 60 may extend to a point just inside the biasing strip 30. In this alternative embodiment, the insulative material may be held in place (and thus coupled with the first layer) by friction between the first layer 10 and the second insulative layer 20, or may be coupled with the first layer via the threaded sewing stitches 20.

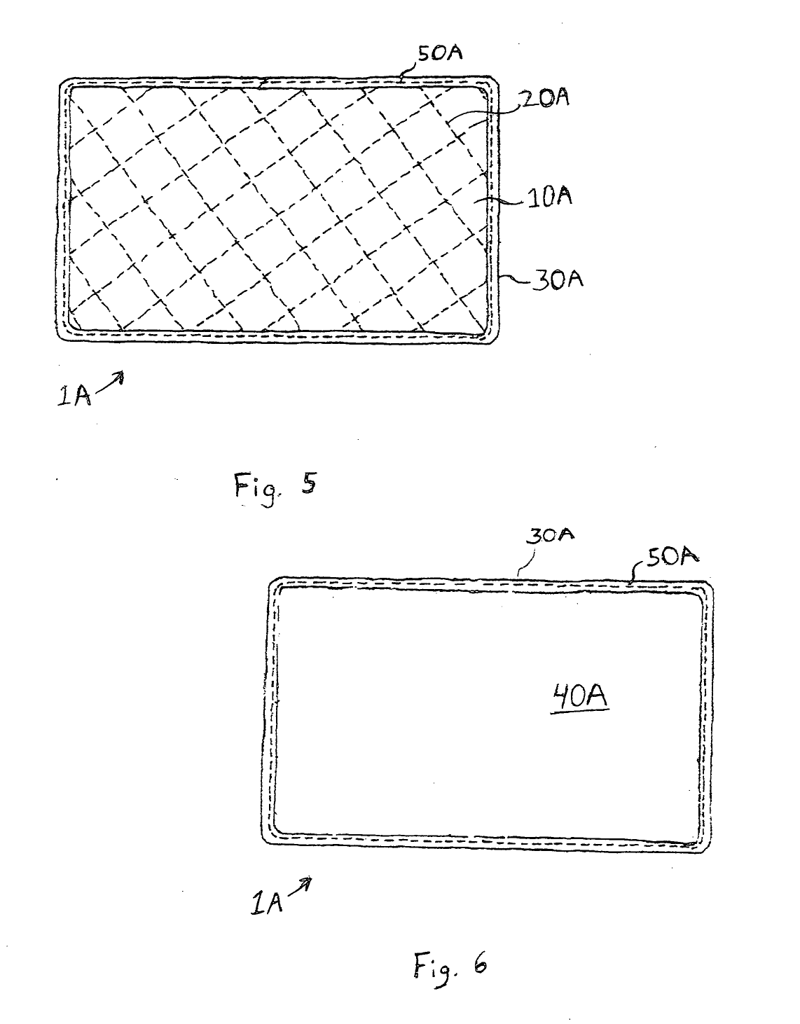

FIG. 5 is a top view of a thermal food cover 1A in accordance with another embodiment of the invention. FIG. 6 is a bottom view of the thermal food cover 1A of FIG. 5, in accordance with an embodiment of the invention. Elements of FIGS. 5 and 6 having the same reference numerals as elements in FIGS. 1-4 except designated with an ‘A’, are the same and will not be discussed in detail.

As shown in FIGS. 5 and 6, the thermal food cover 1A includes a first layer comprising a fabric material 10A. The first layer may be coupled with a second insulative layer (not shown) and a third food-grade, thermally resistant, material 40A. Though not shown, it will be appreciated that the second insulative layer may be the insulative layer 60 (and may include backing 70) as discussed above.

The construction of the food cover 1A may be similar to the construction of the food cover 1 discussed above. The first and second layers may be coupled via threaded sewing stitches 20A. In a further embodiment, the thermal food cover 1A may include a biasing fabric material 30A, coupled about the perimeter of the food cover 1A. The biasing fabric material 30A may be coupled about the perimeter of the food cover, for example, using threaded sewing stitches 50A. It will be appreciated by one skilled in the art that the first, second and third layers 10A, 60A and 40 A respectively, may be coupled via a three-threaded serge stitch such as the three-thread serge stitch 45 discussed above. Other coupling of the various layers 10A, 60A and 40A may be accomplished as discussed above with respect to the coupling of the first, second and third layers 10, 60 and 40 respectively.

The thermal food cover 10A is shown as a rectangular configuration. Such dimensions may be, for example, 11 inches×17 inches for covering large casserole dishes, or 6 inches×9 inches for covering small casserole dishes. Other dimensions may be utilized, appropriate for the particular food item to be covered. Further, it will be appreciated by one skilled in the art that other configurations (not shown) may be utilized, such as a square-shaped configuration thermal food cover.

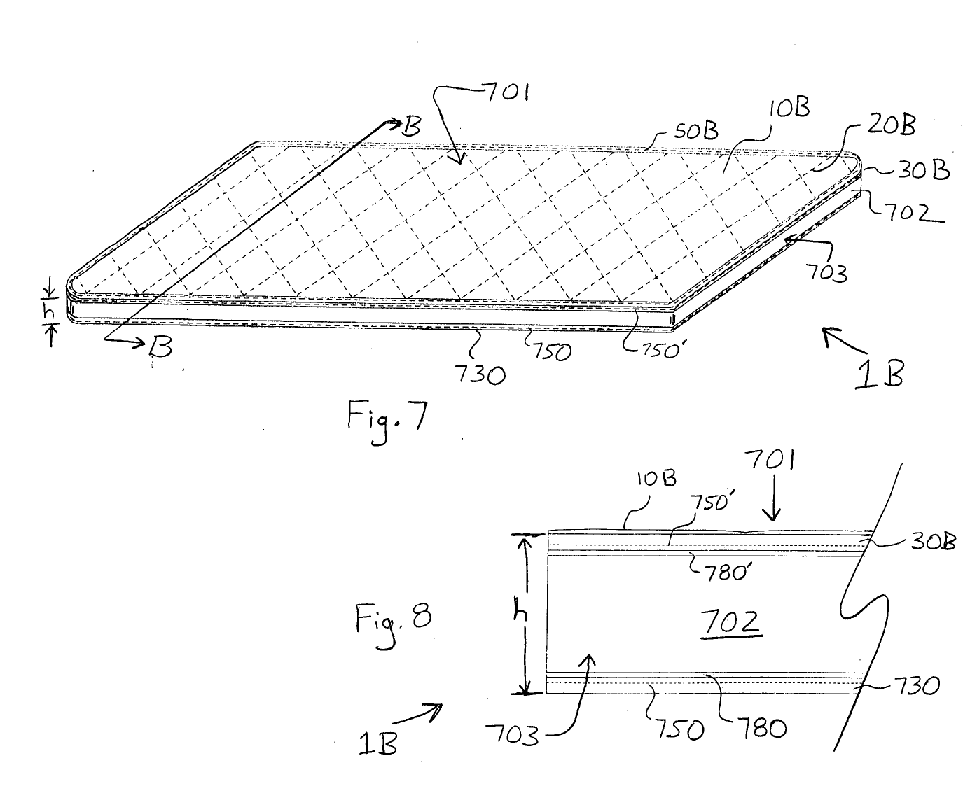

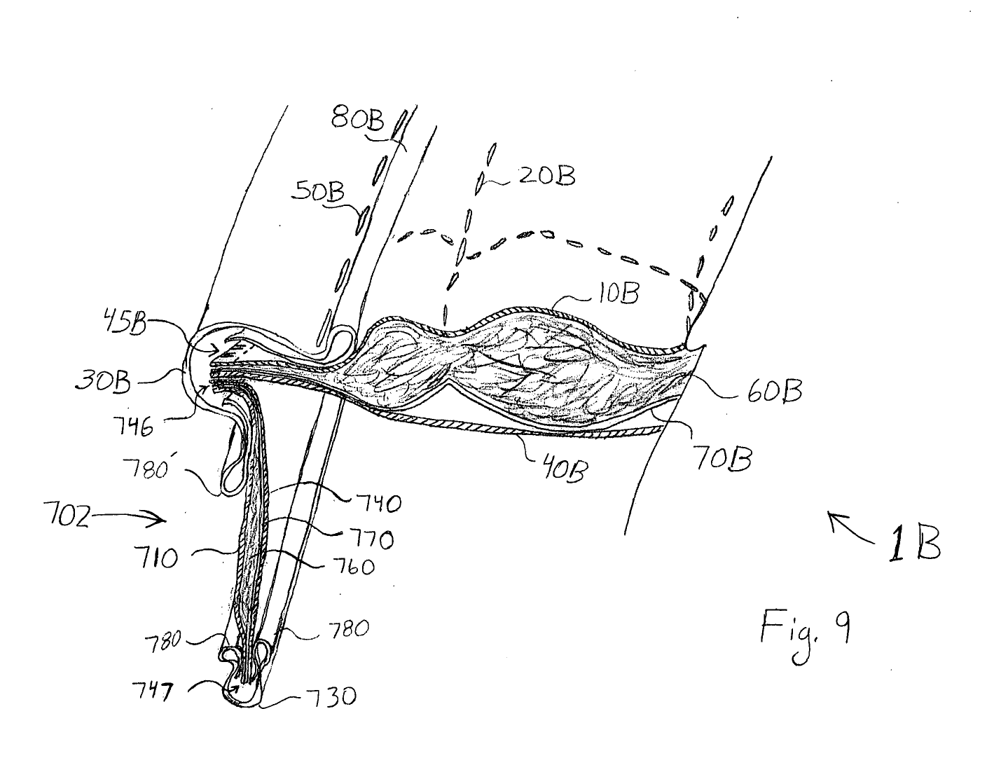

FIG. 7 is a perspective view of a thermal food cover 1B, having a collar, in accordance with an embodiment of the invention. FIG. 8 is a close-up of a partial side view of the food cover 1B of FIG. 7, in accordance with an embodiment of the invention. FIG. 9 is a close-up of a partial sectional-view of the food cover of FIG. 7 along the line B-B and showing some perspective features, in accordance with an embodiment of the invention. Elements of FIGS. 7, 8 and 9 having the same reference numerals as elements identified in FIGS. 1-4 except designated with a ‘B’, are the same and will not be discussed in detail. Further, elements of FIG. 9 having the same reference numerals as elements identified in FIGS. 1-4, except incremented by 700, are the same and will not be discussed in detail.

As shown in FIGS. 7-9, the thermal food cover 1B includes a first layer comprising a fabric layer 10B. The first layer may be coupled with a second insulative layer 60B and a third food-grade, thermally resistant, material 40B. A backing layer 70B may be coupled with the insulative layer 60B, and may be similar to the backing material 70 discussed above. The first and second layers may be coupled via threaded sewing stitches 20B. In a further embodiment, the thermal food cover 1B may include a biasing fabric material 30B, coupled about the perimeter of the food cover 1B. The biasing fabric material 30B may be coupled about the perimeter of the food cover, for example, using threaded sewing stitches 50B. It will be appreciated by one skilled in the art that any of the first, second and third layers 10B, 60B and 40B respectively, may be coupled with one another as discussed above with respect to the first, second and third layers 10, 60 and 40 respectively of the thermal food cover 1 discussed above.

The food cover 1B comprises a substantially planar surface portion shown generally at 701. A collar 702 is shown extending at an angle from the planar surface portion 701, and having a generally planar collar surface portion shown at 703. Here, the collar is shown as extending from the planar surface at substantially a 90° angle (i.e., the angle between the surfaces shown at 701 and 703 is substantially 90 degrees). However, it will be appreciated that the collar may extend at angles at other than a 90° angle. For example, the collar 702 may extend at a generally inward direction where the angle between the surfaces 701 and 703 is of less than 90° angle, or the collar 702 may extend in a generally outward direction where the angle between the surfaces 701 and 703 is greater than a 90° angle.

The collar 702 may include a first layer comprising a fabric layer 710. The first layer may be coupled with a second insulative layer 760 and a third food-grade, thermally resistant, material 740. A backing material 770 may be coupled to the insulative layer 760, and may be similar to the backing layer 70 discussed above. The first, second and third layers 710, 760 and 740 respectively of the collar 702 may be coupled at a proximal portion shown at 746, with the first, second and third layers 10B, 60B and 40B respectively, via the three-thread serge sewing stitch 45B. The first, second and third layers 710, 760 and 740 respectively of the collar 702 may further be coupled at a distal portion shown at 747, via a threaded sewing stitch (not shown) similar to the three-threaded serge sewing stitch 45 discussed above. The collar 702 is shown as having a height ‘h’. The height ‘h’ may be ¾ inch, 1 inch, 1½ inches, or any other desired height.

A biasing fabric material 30B may extend over an outer portion of the collar 702, and be sewn to the collar 702 via a threaded sewing stitch 750′ that may be similar to the threaded sewing stitch 50 discussed above. A bead 780′ may be formed in the bias fabric 30B in a similar fashion as the bead 80 discussed above.

The collar 702 may be trimmed along the distal portion 747 by the biasing fabric material 730, for example, using threaded sewing stitches 750 that may be similar to the threaded sewing stitches 50 discussed above. The bias fabric 730 may comprise a polyester/cotton blend fabric, for example a 50% polyester/50% cotton fabric blend, formed from, for example, a 1½ inch centerfold, of a length appropriate to line the perimeter of the collar 702 along the distal portion 747, where the particular sized centerfold utilized forms the bias shown at 730. Bead 780 may be formed in the bias fabric 730 in a similar fashion as the bead 80 discussed above.

It will be appreciated by one skilled in the art that any of the first, second and third layers 710, 760 and 740 respectively of the collar 702, may be coupled with one another in a similar fashion as discussed above with respect to the first, second and third layers 10, 60 and 40 respectively for the thermal food cover 1. The bias 30B and/or 730 may be formed from similar bias material, and in similar sizes as discussed above with respect to the bias 30.

The collar 702 may be formed and attached to the thermal food cover 1B, for example, by aligning the first, second and third layers 710, 760 and 740 respectively, and stitching the first, second and third layers 710, 760 and 740 to the first, second and third layers 10B, 60B and 40B, along the perimeter of the thermal food cover 1B. Such stitching may be accomplished, for example, using a three-thread serge stitch such as the sewing stitch 45B discussed above. The collar ends may be sewn together by means of a three-thread serge stitch turned inward or reversed.

In an alternate embodiment not shown, the bias material 30B may be cordege material. In this embodiment, the first, second and third layers of the thermal food cover may be coupled with the first, second and third layers of the collar via a threaded sewing stitch (not shown) such as a three-threaded serge sewing stitch 45 discussed above, along the perimeter of the food cover. Such coupling may be accomplished in a similar fashion as discussed above regarding the coupling of the collar 702 at a proximal portion 746 along the perimeter of the thermal food cover 1B. The collar ends may be sewn together by means of a three-thread serge stitch turned inward or reversed. Cording may then be sewn with a lock stitch along the perimeter of the food cover where the food cover meets the collar. This may be accomplished, for example, using a ⅝″ cordedge, 1.25″ bias cut cording. Other cordings may be used, for example, a ¾″ cordedge with a 1.5″ bias cut. Similar to as discussed above, the bottom perimeter of the collar may be trimmed with a 1.5″ center fold bias binding similar to the bias 730 discussed above.

The collar 702 has been discussed above as a single length collar with the ends sewn together with a sewing stitch turned inward or reversed. Though not shown, it will be appreciated that the collar 702 may instead be provided as more than 1 length of collar, where each of the lengths are combined, end-to-end, to form the complete collar 702. For example, the collar 702 may be provided as four lengths, where each length correspond to a side of the perimeter of the food cover, and where combining the four lengths provides the collar 702. Bias material may, but need not, be added where each length end of the collar is joined. Where bias is provided, the bias may be added, for example, in a similar fashion as discussed with respect to the bias 30B of FIG. 9. It will further be appreciated that the lengths of the collar need not be joined to one another. Thus the collar may comprise, for example, four distinct lengths, attached along each side of the perimeter of the food cover 1B, but where the lengths are not attached to one another. This would allow, for example, each of the collar lengths/pieces to be independently moveable with respect to the other collar lengths. It will be further appreciated that not all sides of the food cover need to include a collar. Thus a collar may exist along the perimeter of the food cover at three of the four sides. Similarly, a collar such as the collar 702 may be present on food covers of other shapes/configurations as well, for example, on circular food covers or square food covers.

It will be appreciated that although the collar 702 of FIGS. 7-9 has been described as having bias 30B and 730, one or both of the bias 30B and the bias 730 need not be provided.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

I claim:

1. A thermal food cover, comprising:
a first layer comprising a fabric material;
a second layer coupled with the first layer and comprising an insulative material; and
a third layer coupled with the first layer, and comprising a food-grade, thermally resistant, material.

2. The thermal food cover of claim 1, wherein the third layer is further coupled with the second layer.

3. The thermal food cover of claim 1, wherein the third layer is coupled with the first layer about a perimeter of the thermal food cover.

4. The thermal food cover of claim 1, wherein the fabric material is comprised of a polyester-cotton blend fabric.

5. The thermal food cover of claim 1, wherein the coupling of the second layer with the first layer, and the coupling of the third layer with the second layer, utilizes a threaded sewing stitch.

6. The thermal food cover of claim 5, where the sewing stitch is a modified chain stitch.

7. The thermal food cover of claim 5, where the sewing stitch is a lock stitch.

8. The thermal food cover of claim 1, wherein the insulative material comprises a batting material.

9. The thermal food cover of claim 1, wherein the food-grade thermally resistant material comprises a food-grade polyester polyurethane film.

10. The thermal food cover of claim 9, wherein the food-grade thermally resistant polyester polyurethane film is capable of withstanding temperatures of at least 160 degrees Celsius.

11. The thermal food cover of claim 1, further comprising a biasing fabric material coupled about a perimeter of the thermal food cover.

12. The thermal food cover of claim 11, wherein the biasing fabric material comprises a polyester-cotton blend fabric.

13. The thermal food cover of claim 1, wherein the food cover has a substantially planar portion, and further comprising a collar extending at an angle from the plane of the substantially planar portion.

14. The thermal food cover of claim 1, wherein the second layer is coupled with the first layer to cause a quilting effect.

15. A thermal food cover, comprising:
a first layer comprising a polyester-cotton fabric blend;
a second layer coupled with the first layer via a threaded sewing stitch, and comprising a polyester fiber batting material; and
a third layer coupled with the first layer about the perimeter of the food cover, and comprising a food-grade, thermally resistant, polyester polyurethane film material.

16. A method for retaining thermal properties of a food item, comprising:
placing the food item on a surface; and
covering the food item with a thermal food cover to retain thermal properties of the food item, the food cover comprising
a first layer comprising a fabric material,
a second layer coupled with the first layer and comprising an insulative material, and
a third layer coupled with the first layer, and comprising a food-grade, thermally resistant, material.

17. The method of claim 16, wherein the covering the food item includes covering a container housing the food, where the food item is housed in a container.

18. The method of claim 16, wherein the covering the food item with the thermal food cover to retain thermal properties of the food item includes covering the food item with the thermal food cover to retard the escape of heat from the food item.

19. The method of claim 16, wherein the covering the food item with the thermal food cover to retain thermal properties of the food item includes covering the food item with the thermal food cover to retard the absorption of heat by the food item.
